(19) United States
(12) Patent Application Publication
(10) Pub. No.: US 2004/0197552 A1
(43) Pub. Date: Oct. 7, 2004

(54) Mineral fibre provided with a microporous or mesoporous coating

(76) Inventors: Bertrand Maquin, Paris (FR); Catherine Jacquiod, Gif-sur-Yvette (FR); Didier Lefevre, Les Ulis (FR); Arnaud Marchal, Ecouen (FR); Olivier Larlus, Mulhouse (FR); Anne-Catherine Faust, Mulhouse (FR); Joel Patarin, Flaxlanden (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/484,724

(22) PCT Filed: Jul. 24, 2002
(86) PCT No.: PCT/FR02/02644

(30) Foreign Application Priority Data
Jul. 25, 2001 (FR) 01/09902

(51) Int. Cl. B32B 3/00

(52) U.S. Cl. 428/359

(57) ABSTRACT

The present invention relates to a mineral fibre provided with an essentially mineral microporous or mesoporous coating and to a product comprising such fibres and optionally an organic constituent such as a binder, having a specific surface area at least equal to 10 m²/g, preferably at least equal to 30 m²/g.

The invention also relates to a process for forming a fibre thus coated, by bringing the bare fibre into contact with a composition of organic assembling groups and of at least one precursor of the material constituting the microporous or mesoporous coating, polymerization or precipitation and growth of the precursor around the organic assembling groups and then removal of the organic assembling groups.

Also included in the invention are applications of the coated fibre in catalysis and photocatalysis, in the filtration and treatment of gases and liquids, and its use at temperatures as high as 900° C. or higher, taking advantage of its remarkable withstand capability under such conditions.

The present invention relates to the creation, on mineral fibres, of mineral coatings having pores of dimensions selected from the 0.2 to 50 nm range; in the rest of the description, the term “microporous” refers to pore dimensions from 0.2 to 2 nm and the term “mesoporous” refers to pore dimensions from 2 to 50 nm. These fibres with a specific surface area thus increased are capable of constituting excellent catalyst supports or absorbent elements, especially in the field of the treatment or filtration of liquid or gaseous effluents.

Their catalytic or photocatalytic activity may stem from various modified forms of mesoporous silica: insertion of transition elements into their silica network for the oxidation of olefins, insertion of aluminium for the purpose of acid catalysis, for example for the cracking of hydrocarbons, inclusion of Ni, Mo, Pd, Ag, Cu or Fe metal clusters, or clusters of the oxides of these metals, or TiO₂ for photocatalysis.

In the heavy-metal filtration field, the functionalization of the surface sites by thiol groups makes it possible to, achieve excellent yields. These fibres may also be used for decontaminating effluents containing compounds such as arsenates.

As examples of application, mention may also be made of catalysis reactions intended to reduce the amount of unburnt gases (CO) and also the amount of NOₓ and SOₓ in the combustion of propane, the trapping of relatively fine dust present in a gas, catalysis reactions occurring at temperatures as high as 600 to 900° C., especially in the field of treating industrial hot gases, deodorization in ventilation and heating equipment, clean rooms and passenger compartments of transport vehicles.

Already known, moreover, are materials in powder or granule form sold by Mobil under the name M41S, having pores of dimensions greater than 1.5 nm (the maximum dimension in zeolites). These materials are much sought after in the field of catalysis. This is because their very high specific surface area, the monodispersity of the pore sizes and the low tortuosity of their porous network guarantee high activity, high selectivity and rapid diffusion of the species within the pores, respectively. The relatively large size of their pores make them especially suitable for catalysis involving large-sized compounds.

Application EP-1 044 935 A1 discloses the creation of pores directly on glass fibres by a subtractive process, such as acid etching; document WO-99/37705 A1 mentions the spinnability or drawability of compositions for the purpose of obtaining fibres that are porous throughout their mass. These two types of fibre are relatively brittle and friable, exhibit a level of cohesion that can be improved and have limited mechanical properties.

Patent U.S. Pat. No. 5,834,114 discloses the coating of glass fibres with a phenolic resin, the crosslinking of the latter and then the creation of pores in the coating consisting of the resin, by carbonization of the latter. This document does not specify in what way control of the carbonization parameters allows the size of the pores obtained to be adjusted to a greater or lesser extent. In addition, given the nature of the porous coating and the method of obtaining it, one might expect insufficient mechanical properties, especially abrasion resistance, for applications in which the fibres are most exposed to friction for example.

Consequently, the invention relates to fibres having a microporous or mesoporous surface which can be put into a form having high mechanical strength, such as a mat, a web, a woven, a felt or the like, in which the fibres are, where necessary, combined with a binder. More specifically, the aim of the invention is to make such products available for the conversion of fibres whose specific surface area is increased as required by the envisaged applications mentioned above, whose high mechanical strength and microporosity or mesoporosity persist over long periods, even under demanding use conditions of mechanical stresses, abrasion, high temperatures, corrosion and various forms of chemical attack, and which are inert with respect to active agents, catalysts or the like and are capable of being inserted, or even grafted, into the pores.

For this purpose, the subject of the invention is a mineral fibre provided with an essentially mineral microporous or mesoporous coating. The excellent inherent mechanical properties of the mineral fibres are therefore combined with the mechanical strength and chemical resistance which are provided by the essentially mineral character of the porous coating, the fact that the fibre and its coating are both mineral in addition promoting the adhesion of the second to the first. It will be readily understood that these qualities will ideally be utilized in applications in which a liquid or gas stream possibly laden with solid particles of various masses comes into contact with the fibrous material at a relatively high pressure.

According to preferred embodiments, the fibre of the invention consists of a glass or silica.

The microporous or mesoporous coating is advantageously based on at least one compound of at least one of the elements: Si, W, Sb, Ti, Zr, Ta, V, B, Pb, Mg, Al, Mn, Co, Ni, Sn, Zn, In, Fe and Mo, where appropriate in a covalent bond with elements such as O, S, N, C or the like.

The subject of the invention is also a product comprising such fibres as described above and optionally an organic constituent such as a binder, having a specific surface area at least equal to 10 m²/g, especially at least equal to 30 m²/g. The specific surface areas are extracted from isothermal N₂ adsorption measurements at liquid nitrogen temperature and calculated using the BET model. Most suitably, this product is in the form of a mat, a web, a felt, a wool, chopped fibres, a continuous, especially wound, yarn, or a woven.

Another subject of the invention is a process for creating a microporous or mesoporous coating on fibres for the purpose of obtaining a product as described above. This process comprises:

bringing the fibres into contact with a composition of organic assembling groups and of at least one precursor of the material constituting the microporous or mesoporous coating;

the polymerization or the precipitation and the growth of the molecules of the precursor around the organic assembling groups; and then

the removal of the organic assembling groups.

According to an advantageous method of implementation illustrated by Example 4 below, a nucleation (nucleation of the crystals) temperature of 90 to 150° C. and then a crystal growth temperature of 150 to 190° C. are employed in succession.

Further subjects of the invention are the applications of the coated fibre in catalysis, photocatalysis, in the filtration and treatment of gases or liquids, and its use at high temperature, that is to say up to at least 900° C., and the applications and uses mentioned in detail in the introductory part of this application. In particular, the remarkable strength of the fibre of the invention at high temperature should be emphasized.

The invention is illustrated by the following description of examples of implementation.

### EXAMPLE 1

A web of glass fibres was subjected to the treatment described below. This web may be defined by a weight content of 3% starch, a mean fibre diameter of 12 μm, a specific surface area of less than 0.2 m²/g and the following fibre composition, expressed in percentages by weight:

SiO₂:66.02

Al₂O₃:3.4

CaO:7

MgO:2.95

Na₂O :15.85

K₂O:0.7

B₂O₃:4.5

TiO₂:0.17

Fe₂O₃:0.17

SO₃:0.25.

A strip of the web, 40 cm in width, was continuously coated with a solution by spraying or immersion. The solution contained, per 1 mole of Si(OC₂H₅)₄ (tetraethoxysilane or TEOS for short), 10 mol of water at pH 2 (adjusted by HCl), 40 mol of 96% ethanol and x mol of a polyoxyethylene/polyoxypropylene block copolymer sold by BASF under the registered trade mark PLURONIC PE 6200.

After this spraying or immersion, the web passed through an in-line oven at 200° C. for 10 minutes.

The web was then subjected to a heat treatment comprising:

a temperature rise from room temperature to 175° C. at a rate of 350° C./h;

a temperature hold at 175° C. for two hours;

a rise from 175 to 400° C. at 50° C./h; and

a temperature hold at 400° C. for 12 hours.

This heat treatment was intended to remove the organic assembling groups consisting of the block copolymer, around which assembling groups the polymerization of the silica precursor TEOS was polymerized. This removal left a porous network in place.

The heat treatment had another effect of removing the starch initially present in the web.

The percentage by weight of deposited coating with respect to the initial weight of the web, reduced by the initial weight of starch, the specific surface area (measured as described above) of the web thus treated and the mean diameter of the pores were determined using the method of desorption isotherms according to the BJH model. The results are given in the tables below, in which x denotes the number of moles of block copolymer present in the treatment solution per mole of TEOS.

TABLE 1
(immersion)

| | | | |
|---|---|---|---|
| x | 0.123 | 0.171 | 0.245 |
| % of coating | 10.6 | 10.4 | 11.2 |
| Specific surface area (m²/g) | 38 | 45 | 37 |
| Pore diameter (nm) | 3.6 | 3.2 | 3.2 |

TABLE 2
(spraying)

| | | |
|---|---|---|
| x | 0.016 | 0.049 |
| % of coating | 4.9 | 11.7 |
| Specific surface area (m²/g) | 48 | 48 |
| Pore diameter (nm) | 2 | 3 to 4 |

### EXAMPLE 2

A 2 m×0.4 m silica felt specimen, having a specific surface area of less than 0.3 m²/g, was treated with the solution described in the previous example, in which x was equal to 0.082.

The specimen, driven by a conveyor belt at a speed of 30 m/h, was subjected in succession to immersion in the solution, to suction through the belt by a vacuum of 150 mm of water in the case of a first specimen and more than 220 mm of water in the case of a second specimen, and then to passage through an oven at 230° C. intended to evaporate the solvents.

Next, the specimen was calcined according to the same heat cycle as described in Example 1 so as to remove the organic assembling groups in order to form the porous network as explained above.

The weight uptake by the specimens before and after calcining was measured; the results are given in Table 3 below.

TABLE 3
(% weight uptake)

| | First specimen | Second specimen |
|---|---|---|
| Before calcining | 13 | 16 |
| After calcining | 7 | 14 |

The specific surface area was determined by the same method as above: 86 m²/g and 87 m²/g for the first and second specimens respectively. In the same order, a median pore radii were 6.7 and 6.8 nm respectively. The distribution of the specific surface areas as a function of the pore radii is given in the table below. In this table, A % denotes the proportion of specific surface area associated with the indicated range of pore radii.

TABLE 4
(distribution of the specific surface areas as a
function of the pore radii)

| | | First specimen | Second specimen |
|---|---|---|---|
| From (nm) | To (nm) | A % | A % |
| 0 | 1.5 | 5.7 | 3.6 |
| 1.5 | 3 | 54.0 | 41.7 |
| 3 | 5 | 29.4 | 36.4 |
| 5 | 10 | 8.4 | 14.3 |
| 10 | 50 | 1.6 | 2.0 |

### EXAMPLE 3

A web of textile fibres 15 μm in diameter, made of glass having the following composition, expressed in percentages by weight, was treated:

SiO₂:55.8

Al₂O₃:13

CaO:23

MgO:0.3

Na₂O:0.5

K₂O:0.3

B₂O₃:6.2

TiO₂:0.11

Fe₂O₃:0.12

SO₃:0.57.

This web was furthermore characterized by a specific surface area of less than 0.2 m²/g.

A composition, called gel E was prepared, this comprising, in moles:

5 TPAOH (tetra-n-propylammonium hydroxide);

25 SiO₂;

420 H₂O.

To do this, 10.015 g of a mixture of 30 wt % of silica and 70 wt % of water, sold by Aldrich under the brand name LUDOX HS-30 and 10.169 g of 20 wt % TPAOH in water were mixed together.

The mixture was then immersed in an amount of gel E defined above, such that its mass was 6 times greater than that of the fibres, and held at 170° C. for 6 hours 30 minutes.

The organic assembling groups coming from the TPAOH were in this case removed by flash calcination: the web was introduced into an oven preheated to 480° C. and held therein for 2 hours.

The specific surface area was measured in the manner explained above and a value of 140 m²/g was obtained. Almost all of the pores formed in the silica were in the pore size (diameter) range from 3 to 8 Å, which dimensions characterize a zeolite.

A fibre at least 2 cm in length was isolated from the web before and after its porous coating was formed and the Individual Tensile Strength was determined, that is to say one end of each fibre was adhesively bonded and the tensile force needed to break it measured. This made it possible to determine on two groups of fibres, before and after treatment, a mean mechanical remanence of 25%, defining the percentage retention of the mechanical properties.

### EXAMPLE 4

A web of glass fibres having the same specific surface area and the same composition as Example 3 was treated.

Two solutions of the following molar compositions were prepared:

gel H (4 TPAOH:25 SiO₂:420 H₂O); and

gel I (3 TPAOH:25 SiO₂:420 H₂O),

as indicated in Example 3 in the case of gel E.

The compositions and the fibres were brought into contact with one another in a composition/fibre mass ratio of 6, firstly at a relatively low nucleation (i.e. nucleation of the crystals) temperature (130° C.) and then secondly at a higher temperature (170° C.) at which the actual crystallization (i.e. the growth of the crystals) takes place.

These operations were followed, as in the previous examples, by removal of the organic assembling groups coming from the TPAOH, by the following heat treatment: passage from room temperature to 200° C. in 30 min, temperature hold at 200° C. for 1 hour, rise to 500° C. over 2 hours and hold at this temperature for 3 hours, then cooling to room temperature by inertia.

The specific surface area was determined in the manner explained above and the percentage by weight of coating formed was determined by X-ray diffraction, using porous coating/fibre standards on the one hand and fibres treated according to the invention on the other, by calculating the area of the peaks after subtraction from the baseline. The results are given in the table below.

TABLE 5

| | Gel | | | | |
|---|---|---|---|---|---|
| | H | I | I | I | I |
| Nucleation | 4 h-130° C. | 4 h-130° C. | 3 h-130° C. | 4 h-130° C. | 3 h-130° C. |
| Crystallization | 3 h-150° C. | 3 h-150° C. | 1 h-170° C. | 1 h-170° C. | 2 h-170° C. |
| SEM thickness | 1.1 μm | 3 μm | 1 μm | 2.7 μm | 2.5 μm |
| Specific surface | 35 | 107 | 30 | 93 | 84 |
| area (m²/g | | | | | |
| State of the fibres | very good | average | good | average | average |
| % weight of coating | 8.8-10 | 26.8-30.6 | 7.5-8.6 | 23.3-26.6 | 21-24 |

The pore diameters were almost entirely between 3 and 8 Å as in Example 3. It may be seen that using a nucleation temperature and a crystallization temperature as described above makes it possible to reduce the time taken to form the coating and increase the adhesion of the porous coating to the fibre. High specific surface areas are achieved.

The mechanical remanences, as defined in Example 3, were at least 25%, which allows application as a zeolite to be envisaged under the most demanding mechanical stress conditions.

1. Mineral fiber provided with an essentially mineral microporous or mesoporous coating.

2. A fiber according to claim 1, consisting of a glass or silica.

3. A fiber according to claim 1, in which the said microporous or mesoporous coating is based on at least one compound of at least one of the elements selected from the group consisting of Si, W, Sb, Ti, Zr, Ta, V, B, Pb, Mg, Al, Mn, Co, Ni, Sn, Zn, In, Fe and Mo.

4. Product comprising fibers according to claim 1 and optionally an organic constituent such as a binder, having a specific surface area at least equal to 10 m²/g, especially at least equal to 30 m²/g.

5. Process according to claim 4, in the form of a mat, a web, a felt, a wool, chopped fibers, a continuous, especially wound, yarn, or a woven.

6. Process for creating a microporous or mesoporous coating on fibers for the purpose of obtaining a product according to claim 4, comprising:
bringing the fibers into contact with a composition of organic assembling groups and of at least one precursor of the material constituting the microporous or mesoporous coating;
the polymerization or the precipitation and the growth of the molecules of the precursor around the organic assembling groups; and then
the removal of the organic assembling groups.

7. Process according to claim 6, in which a nucleation temperature of 90 to 150° C. and then a crystal growth temperature of 150 to 190° C. are employed in succession.

8. Application of a fiber according to claim 1, inserted into the microporous or mesoporous network of which are transition elements, for the oxidation of olefins.

9. Application of a fiber according to claim 1, inserted into the microporous or mesoporous network of which is Al, in acid catalysis, especially for the cracking of hydrocarbons.

10. Application of a fiber according to claim 1, included into the microporous or mesoporous network of which are Ni, Mo, Pd, Ag, Cu or Fe metal clusters, or clusters of the oxides of these metals, or TiO₂, in catalysis or photocatalysis.

11. Application of a fiber according to claim 1, the surface sites of which are functionalized by thiol groups, in the filtration of heavy metals or the decontamination of effluents consisting of arsenates or the like.

12. Application of a fiber according to claim 1, in catalysis reactions intended to reduce the amount of unburnt CO and/or the amount of NOₓ and SOₓ, especially in the combustion of propane.

13. Application of a fiber according to claim 1, to the trapping of dust in a gas.

14. Application of a fiber according to claim 1, to the treatment of industrial hot gases.

15. Application of a fiber according to claim 1, to deodorizing in ventilation and heating equipment, clean rooms, passenger compartments of transport vehicles or other enclosures.

16. Use of a fiber according to claim 1, at high temperature, especially up to 900° C.
